(19) United States
(12) Patent Application Publication
(10) Pub. No.: US 2010/0261610 A1
(43) Pub. Date: Oct. 14, 2010

(54) USE OF GLYCEROL, METHOD OF CROP TREATMENT, COMPOSITION FOR TANK MIXING AND A METHOD OF PREPARATION OF A COMPOSITION FOR TANK MIXING

(75) Inventors: Walter Dissinger, Sao Paulo (BR); Edson Begliomini, Sao Paulo (BR); Tadashi Yotsumoto, Sau Paulo (BR); Marco-Antonio Tavares-Rodrigues, Sao Paulo (BR)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/740,227

(22) PCT Filed: Oct. 24, 2008
(86) PCT No.: PCT/EP2008/064445

§ 371 Date: Apr. 28, 2010

(30) Foreign Application Priority Data
Oct. 30, 2007 (BR) PI0704008-3

(51) Int. Cl. A01N 25/02

(52) U.S. Cl. 504/362; 514/772

(57) ABSTRACT

The present invention relates to a method for the treatment of crops, comprising the steps of
1) preparation of a spraying solution by mixing of
   1.1) at least one agrochemical composition, and
   1.2) raw glycerol derived from the production of biodiesel; and
2) application of said spraying solution on the soil and/or crop and/or weeds and/or pests and/or their locality and/or habitat.

Further on, it relates to the use of raw glycerol derived from the production of biodiesel in the preparation of a spraying solution which comprises at least one agrochemical composition. Additionally, a spraying solution is disclosed comprising water, raw glycerol derived from the production of biodiesel and an agrochemical composition.

### FIELD OF INDUSTRY

The present invention relates to the use of glycerol, optionally with vegetable and/or mineral oil, as adjuvant or coadjuvant in the preparation of a spraying solution for improving the efficacy of agrochemicals, such as insecticides and acaricides in pest control, fungicides in the control of diseases, herbicides in the control of weeds, plant growth regulators, preharvest desiccants and foliar fertilizers for nutritional deficiencies. A method of crop treatment using glycerol, optionally with vegetable and/or mineral oil, according to the invention, is preferably carried out in a system with low spraying volume, with high performance and low required volume of water. The invention also relates to a composition for tank mixing to be applied on crops and soil, as well as a method of preparation thereof. Said glycerol can be obtained from biodiesel concerns located in regions of agricultural production.

Furthermore, the present invention relates to a method for the treatment of crops, comprising the steps of 1) preparation of a spraying solution (“tank mix”) by mixing of 1.1) at least one agrochemical composition, and 1.2) raw glycerol derived from the production of biodiesel; and 2) application of said spraying solution on the soil and/or crop and/or weeds and/or pests and/or their locality and/or habitat. The invention also relates to a use of raw glycerol derived from the production of biodiesel in the preparation of a spraying solution which comprises at least one agrochemical composition. Further on, it relates to a spraying solution (tank mix) for agricultural application, comprising water, raw glycerol derived from the production of biodiesel and an agrochemical composition.

Combinations of preferred embodiments with other preferred embodiments are within the scope of the present invention

The development of adjuvants has significantly increased efficiency in the spraying of agricultural products through the introduction of new methods, where significant gains in performance can be observed owing to better distribution, dispersion, absorption, resistance to rain, as well as reduction of antagonism and other properties. Initially, the adjuvants were developed primarily for the spraying of herbicides, improving the dispersion and distribution, and principally with better absorption of the product, thus increasing the efficiency of spraying with reduction of product loss through drift, and consequently reducing the amount of product in the environment. Agriculture has become more developed. Thus, increased efforts were made to secure improvement of performance and efficacy of applications as well as improvements for the environment, reducing the emissions of product in the environment through significant reduction of losses. Another important factor in this process is progressive shortage of water and better use of this resource; because of these factors, the use of adjuvants has also expanded along with methods of agricultural treatment of insecticides and acaricides in pest control, fungicides in the control of diseases, plant growth regulators, preharvest desiccants and foliar fertilizers, improving the efficiency in spraying, increasing the wettability of the product, the coverage and uniformity of spraying, area of contact and the penetration of the solution through the cuticle of the leaves. This has led to an increase in ingress through the intercellular spaces and stomata, not restricted exclusively to use with herbicides, but also with other types of product. With the expansion of agriculture, for example in Brazil, a method of agricultural treatment has been developed, principally in the area of the “cerrado” (savanna), with low-volume spraying of solution called Low Oil Volume (LOV), using low doses of spraying solution through the use of vegetable oil as supplement, a method of large-area treatment due to the effects as coadjuvant of vegetable oil for improving application performance.

An article with the title “Impact, diagnosis and handling of Asiatic rust of soybean in Brazil”, Silvânia H. Furlan (Summa Phytopathologica, 2005, 31, 119-120, 2005), states that spraying of fungicides on a soybean plantation by means of a Low Oil Volume system, carried out with an airplane, can be more economically effective using soya oil, which provides better spraying in comparison with spraying without oil. Kapusta (J. Am. Chem. Oil Soc., 1985, 62, 923-926) disclosed the use of soybean oil as carrier for herbicides in spray applications. Shellhorn and Hull (Weed Science, 1971, 19(1), 102-106) disclosed a carrier composition comprising 25 wt % glycerol and 70 to 75 wt % water, or wt % glycerol, 15 wt % isoparafinic phytobland oil (i.e. mineral oil) and 60 wt % water. The carrier compositions were applied in lab trials by means of a micrometer-driven syringe without a needle in amounts of 40 μl per plant. Brazilian patent application BRPI0703636 published on Apr. 1, 2008 disclosed the use of glycerol obtained from the production of biodiesel for the production of a solution with anti-evaporation characteristics and greater adhesion to the surface of plants. The glycerol was a clean product and free from toxic substances.

Glycerol (CH₂(OH)CH(OH)CH₂OH) is also known as 1,2,3-propanetriol or glycerine, and belongs to the chemical group of alcohols, a by-product from processes of production of biodiesel, with melting point in the range from 16 to 20° C. (18° C.), boiling point in the range from 260 to 320° C. (290° C.), density from 1.2 to 1.5, physical state: liquid, viscous and hygroscopic. As is already known in industry, biodiesel has become an alternative source of biofuel from a renewable source, being produced, basically, from vegetable oils or fat of animal origin. Biodiesel is obtained by a process called transesterification, which results in the separation of the esters contained in the oils from the glycerol by the use of an alcohol; accordingly, the process has glycerol as a by-product. This glycerol is marketed with an impurities content that can vary from 0.01 wt. % to 50 wt. % and other impurities, such as methanol (about 0.2 wt. %), sodium chloride (about 10 wt. %) and ash (about 10 wt. %), depending specifically on the production technology employed. Accordingly, the purity of glycerol varies from 50 wt. % to close to 99.9 wt. %, refined and unrefined. Owing to the benefits of biodiesel—in that it comes from a renewable source, reducing the emission of gases that cause the green-house effect, the increasing demand for energy generated cleanly, reduction of dependence on imports of petroleum derivatives, besides the social aspect and generation of income in a sustainable manner, we see a rapid expansion of the industry dedicated to the production of biodiesel, especially in areas of production of oil crops, as in the case of the Brazilian “cerrado” (savanna).

One of the effects of the large-scale production of biodiesel will be a considerable increase in supply of glycerol. Despite various possible industrial uses of glycerol, the surplus of glycerol will be a challenge for the biodiesel industry. Since there is insufficient demand for glycerol, the surplus can become a waste disposal problem for the biodiesel production plants. At present glycerol is used, at different purities, principally in the synthesis of resins, in pharmaceutical applications; cosmetics, foodstuffs and others have led to other uses for glycerol in place of other chemicals. Glycerol is also used in product compositions, in certain types of formulations of baits for pest control or in the formulation of certain products for treatment of seeds, as a component in the formulation or composition of some agricultural products. The industrial-scale production of biodiesel generates about 15% of glycerol for each tonne of biodiesel produced. Taking into account the rapid advance of production plants, the supply of glycerol will increase at the same rate as the installation of new plants for production of glycerol. Another fundamental point is the logistic question: with the concentration of industrial units in agricultural regions, the cost of transporting a considerable volume of glycerol so that it can be used in other conventional industrial applications is economically un-viable. If there is no suitable destination site close to the production site, the glycerol will become an environmental liability that will have to be treated appropriately, meaning an increase in capital expenditure and running costs and a consequent reduction of economic attractiveness for these biodiesel production plants. As the production of biodiesel is being consolidated close to agricultural centers, if a new sustainable use for glycerol is found within the agricultural processes and operations this will have a beneficial impact for these processes.

The use of glycerol mixed directly in the water for the spraying solution would theoretically not be recommended owing to the temperature rise caused by mixing with water. The increase in temperature would consequently increase the risk of phytotoxicity, leading to a heat demand, and causing damage when the glycerol comes into contact with plants.

With the need to improve the agricultural treatment techniques, the method of spraying in a small volume of solution or Low Oil Volume (LOV) has been used. This type of spraying brought some benefits, principally for the areas of the Brazilian “cerrado” (savanna), where it is necessary to optimize the use of water and increase the performance of agricultural treatments with reduction of the volume of spraying solution and the capacity for treatment of larger areas with the same equipment. Aerial application by LOV can treat 1000 ha per day in comparison with conventional treatment of 600 ha per day. In aerial and terrestrial applications, the consumption of solution was reduced to 50% compared to standard aqueous treatments.

The conventional form includes (1) agrochemical+(2) water in normal volume from approximately 150 to approximately 200 liters per hectare, or high volume of up to approximately 600 liters per hectare, in the case of agricultural treatments for pest and disease control, depending on the type of crop. The disadvantage of this technique is the need for a high volume of water that is not always available to farmers, with low treatment capacity by area per equipment per day in comparison with LOV (Low Oil Volume).

A first object of the present invention was to use an adjuvant or coadjuvant in the preparation develop of a spraying solution comprising agricultural treatment compositions that provides an improved method of crop treatment and/or weeds and/or pests and/or their locality and/or habitat, displaying high performance and low demand for volume of water. and, consequently, proving beneficial by means of derivatives from biodiesel production. A second object of the present invention is to provide a method for the treatment of crops and/or weeds and/or pests and/or their locality or habitat, using glycerol as adjuvant or coadjuvant in the preparation of a spraying solution comprising agrochemical compositions, to be applied to the soil and/or crops. A third object of the present invention is to provide a composition for tank mixing to be applied on the crops and/or soil and/or weeds and/or pests and/or their locality and/or habitat. A fourth object of the present invention is to provide a method for the preparation of the aforementioned composition for tank mixing. Yet another object of the present invention was to develop a spraying solution comprising agricultural treatment compositions that provides an improved method of crop treatment and/or weeds and/or pests and/or their locality and/or habitat, displaying high performance and low demand for volume of water.

The object was solved by a method for the treatment of crops, comprising the steps of 1) preparation of a spraying solution (“tank mix”) by mixing of 1.1) at least one agro-chemical composition, and 1.2) raw glycerol derived from the production of biodiesel; and 2) application of said spraying solution on the soil and/or crop and/or weeds and/or pests and/or their locality and/or habitat.

### DETAILED DESCRIPTION OF THE INVENTION

It was verified that a method of agricultural treatment using glycerol as adjuvant or co-adjuvant in systems for agricultural treatments, namely the system Glycerol for Agricultural Spraying (GAS) with systems for control of weeds with herbicides and systems for treatment for control of diseases with fungicides, demonstrating the practicability of the method for any agricultural treatment based on the results for tolerance of the crops tested with the method involving glycerol in that it has beneficial effects on the systems. The present invention relates to the use of glycerol as adjuvant or coadjuvant in the preparation of an agricultural spraying solution comprising compositions for agricultural treatment. The present invention further relates to a method of crop treatment comprising glycerol, optionally with vegetable and/or mineral oil, as adjuvant or coadjuvant and at least one agrochemical composition in the preparation of an agricultural spraying solution to be applied to the soil and/or crop and/or weeds and/or pests and/or their locality and/or habitat.

The present invention relates to a method for the treatment of crops, comprising the steps of 1) preparation of a spraying solution (“tank mix”) by mixing of 1.1) at least one agrochemical composition, and 1.2) raw glycerol derived from the production of bio-diesel; and 2) application of said spraying solution on the soil and/or crop and/or weeds and/or pests and/or their locality and/or habitat. Preferably, step 1) comprises the mixing of 1.1) at least one agrochemical composition, 1.2) raw glycerol, and 1.3) vegetable and/or mineral oil.

A spraying solution typically comprises an agrochemical composition of a pesticide and a liquid carrier. A spraying solution is also referred to as tank mix. Usually, the spraying solution is prepared by mixing an agrochemical composition an a liquid carrier in the tank of the application equipment, preferably less than 12 h before application.

In general, agrochemical compositions are commercially available, solid or liquid, concentrated compositions comprising a pesticide. For example, the agricultural compositions include products with types of formulations of suspension of encapsulated products (CS), dispersible concentrate (DC), emulsifiable concentrate (EC), concentrated suspension (SC), suspo-suspension of encapsulated products (SCS), suspo-emulsion (SE), soluble granule (SG), soluble concentrate (SL), soluble powder (SP), water-soluble tablets (ST), water-dispersible tablets (WT), granules dispersed in water (WG), wettable powder (WP). Preferably, types of formulations of suspo-emulsions (SE), soluble concentrate (SL), emulsifiable concentrate (EC) and concentrated suspension (SC) are used. More preferably, the forms of soluble concentrate (SL), concentrated suspension (SC), wettable powder (WP), suspo-emulsion (SE) and emulsifiable concentrate (EC) are used. The agrochemical compositions should not directly be applied, but have to be diluted with a liquid carrier prior to application. Known carriers are for example water or oils, such as vegetable oils.

Raw glycerol is derived from the production of biodiesel. Preferably, the biodiesel is produced from vegetable oils and animal fats by transesterification, especially by transesterification with methanol. More preferably, raw glycerol is derived from the alkaline catalyzed transesterification of vegetable or animal oils or fats, preferably from vegetable oils or fats. The aforementioned processes have raw glycerol as a by-product. This raw glycerol is marketed with an impurities content that can vary from 0.01 wt. % to 50 wt. %. Typically, raw glycerol has impurities, such as methanol (about 0.2 wt. %), sodium chloride (about 10 wt. %) and ash (about 10 wt. %), depending specifically on the production technology employed. The impurity contents of raw glycerol may vary from 0.01 wt. % to 50 wt. %. In a preferred embodiment, the impurity contents is in the range of 5 to 50 wt %, preferably 10 to 40 wt %, and especially preferred 15 to 35 wt %, based on the total weight of the raw glycerol. Accordingly, the glycerol purity varies from 50 wt. % to 99.9 wt. %, refined and unrefined. The preferred raw glycerol is raw glycerol with 80 wt. % purity.

The raw glycerol by-product stream from a biodiesel plant is typically comprised of glycerol, methanol, water, inorganic salts (catalyst residue), free fatty acids, unreacted mono-, di-, and triglycerides, methyl esters, as well as a variety of other matter organic non-glycerol (MONG) in varying quantities. The methanol is typically stripped from this stream and recycled, leaving behind, after neutralization, what is known as raw glycerol (also known as crude glycerol). In raw form, crude glycerol typically has a high salt and free fatty acid content and substantial color (yellow to dark brown). For example, if the transesterification of the biodiesel process was base catalyzed and if the base was CH₃ONa and neutralized with HCL, then the salt will be NaCl. If the base was CH₃OK, then the salt will be KCl. Consequently, crude glycerol has few direct uses because of the presence of salts and other species, and its fuel value is marginal.

Usually, raw glycerol can include a byproduct derived from the production of biodiesel from vegetable oils and animal fats. The vegetable oils for the production of biodiesel are typically derived from agricultural crops, such as soybean (Glycine max), sunflower (Helianthus annuus), castor-oil plant (Ricinus communis), cotton (Gossypium hirsutum), oil-palm (Attalea speciosa M.), Brazilian oil palm (Elaeis guineensis N.), ground-nut (Arachis hypogaea), colza (Brassica campestris), avocado (Persia americana), coconut (Cocos nucifera), maize (Zea mays), cashew nut (Anacardium occidentale), oats (Avena sativa), lupine (Lupinus albus), coffee (Coffeea arabica), flax (Linum grandiflorum), rice (Oryza sativa), cocoa (Theobroma cacao), canola (Brassica napus), olives (Olea europaea), pecan nut (Carya illinoensis), jojoba (Simmondsia chinensis), macadamia (Macadamia ternifolia), Brazil-nuts (Bertholletia excelsa), and other cultivars. Each of these crops has vegetable oil content varying from approximately 7 to approximately 66 wt. %.

In general, raw glycerol comprises various impurities, such as inorganic salt and methanol. Preferably the inorganic salt is a sodium or potassium salt or a salt of chloride. Especially preferred salts are sodium chloride or potassium chloride. The amount of inorganic salt is usually at least 1.0 wt %, preferably at least 2.5 wt %, more preferably at least 4.0 wt % based on the total weight of the raw glycerol. The inorganic salt may be present in 1.0 to 20 wt %, preferably in 2.5 to 15 wt % and more preferably in 4.0 to 12.0 wt %. For example, sodium chloride is present in about 10 wt. %, depending specifically on the production technology employed. Methanol is in general present in amounts up to 1.0 wt %, preferably up to 0.8 wt % and more preferably up to 0.5 wt %. Often, methanol is present in amounts of 0.05 to 1.0 wt %, preferably 0.1 to 0.8 wt %. For example, the methanol is present in about 0.2 wt. %.

Optionally, the tank mix comprises vegetable and/or mineral oil. Preferably, it comprises vegetable oil, especially degummed vegetable oils. Examples for degummed vegetable oils are oils from soybean (Glycine max), sunflower (Helianthus annuus), castor-oil plant (Ricinus communis), cotton (Gossypium hirsutum), oil-palm (Attalea speciosa M.), Brazilian oil palm (Elaeis guineensis N.), groundnut (Arachis hypogaea), colza (Brassica campestris), avocado (Persia americana), coconut (Cocos nucifera), maize (Zea mays), cashew nut (Anacardium occidentale), oats (Avena sativa), lupine (Lupinus albus), coffee (Coffeea arabica), flax (Linum grandiflorum), rice (Oryza sativa), cocoa (Theobroma cacao), canola (Brassica napus), olives (Olea europaea), pecan nut (Carya illinoensis), jojoba (Simmondsia chinensis), macadamia (Macadamia ternifolia), Brazil-nuts (Bertholletia excelsa). Preferably, soya or cottonseed oils are used, with purity varying from 70 wt. % to 99 wt. %. Mineral oil is a by-product in the distillation of petroleum to produce gasoline. It is usually transparent, colorless oil composed mainly of alkanes (typically 15 to 40 carbons) and cyclic paraffins. Examples are paraffinic oils (based on n-alkanes), naphthenic oils (based on cycloalkanes) and aromatic oils (based on aromatic hydrocarbons).

Typically, adjuvants are solvents, carriers, ionic or non-ionic surfactants or antifoaming agents. Examples are derivatives of chemical groups of mineral oils, organic silicones, ethoxylated alcohols, ethoxylated esters, tallow amines, phenols, and hybrid pre-mixes of adjuvants of mineral oil and methyl ester, adjuvants of nonionic surfactants or mixtures thereof. Preferably, an adjuvant is a ionic or non-ionic surfactant, especially a nonionic surfactant is used. Suitable ionic or non-ionic surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene deriva-tives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose. Preferred non-ionic surfactants are polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters.

The present invention further relates to a spraying solution comprising water, raw glycerol derived from the production of biodiesel and an agrochemical composition. The spraying solution may be composed of 1 to 20 wt. % of glycerol relative to the total weight of the composition. Preferably, the composition of the invention comprises 1 to 20 wt. % of glycerol and 0 wt. % to 13 wt. % of oil relative to the total weight of the composition. More preferably, said composition is formed from 1 wt. % to 20 wt. % of glycerol, 0 wt. % to 13 wt. % of oil and 19 wt. % to 99 wt. % of water relative to the total weight of the composition. More preferably, said composition is formed from 1 wt. % to 20 wt. % of glycerol, 0 wt. % to 13 wt. % of oil, 19 wt. % to 99 wt. % of water and 0.05 wt. % to 1 wt. % of adjuvants relative to the total weight of the composition. Even more preferably, said spraying solution comprises, preferably is formed from:

1 wt. % to 20 wt. % of raw glycerol,
0 wt. % to 13 wt. % of oil,
19 wt. % to 99 wt. % of water,
0.05 to 1 wt. % of adjuvants, and
0.001 to 60 wt. % of agrochemical composition
wherein the wt % are relative to the total weight of the composition.

The spraying solution, according to the present invention, used with low spraying volume, comprises typically:

a) for aerial application:
5 to 40 liters q.s.f. of water per hectare, preferably 5 to 15 liters q.s.f. of water per hectare,
0.05 to 4 liters of raw glycerol for 5 to 40 liters q.s.f. of water per hectare, preferably 1 to 4 liters per hectare per 5 to 15 liters q.s.f. of water per hectare,
0 to 5.0 liters of vegetable oil for 5 to 40 liters q.s.f. water per hectare, preferably 0.5 to 2.0 liters of vegetable oil for 5 to 15 liters q.s.f. of water per hectare,
0.003 to 0.4 liters or kg of adjuvant per hectare for 5 to 40 liters q.s.f. of water per hectare, preferably 0.013 to 0.2 liters or kg of adjuvant per hectare for 5 to 15 liters q.s.f. of water per hectare, and
0.003 liters or kg to 6 L or kg of agrochemical composition per hectare for 5 to 40 liters q.s.f. of water per hectare, preferably 0.1 to 3 liters or kg per hectare per 5 to 15 liters q.s.f. of water per hectare,
   b) for terrestrial application:
15 to 600 liters q.s.f. of water per hectare, preferably 15 to 30 liters q.s.f. of water per hectare,
0.15 to 24 liters of raw glycerol for 15 to 600 liters q.s.f. of water per hectare, preferably 1 to 4 liters of raw glycerol per hectare per 15 to 30 liters q.s.f. of water per hectare,
0 to 2 liters vegetable oil per hectare for 15 to 30 liters q.s.f. of water per hectare, preferably 0.5 to 2.0 liters vegetable oil per hectare for 15 to 30 liters q.s.f. of water per hectare,
0.038 to 6.0 liters adjuvant per hectare for 15 to 600 liters q.s.f. of water per hectare, preferably 0.038 to 0.15 L/ha adjuvant for 15 to approximately 30 liters q.s.f. of water per hectare, and
0.003 to 6 L or kg per hectare of agrochemical composition per approximately 15 to approximately 600 liters q.s.f. of water per hectare, preferably 0.1 to 3.0 liters of agrochemical composition per hectare per 15 to 30 liters q.s.f. of water per hectare,
   wherein the percentage by weight of each ingredient is relative to the total weight of the composition.

In another preferred embodiment, the spraying solution may comprise water, raw glycerol and an agrochemical composition. Preferably, the raw glycerol in said spraying solution comprises 60 wt % to 90 wt % glycerol and 1.0 wt % to 20 wt % of inorganic salt relative to the weight of the raw glycerol. More preferably, said spraying solution comprises 1 wt % to 20 wt %, preferably 2 wt % to 14 wt % of raw glycerol. Even more preferably, said spraying solution comprises 1 wt % to 20 wt % of raw glycerol relative to the total weight of spraying solution, wherein the raw glycerol comprises 60 wt % to 90 wt % glycerol and 1.0 wt % to 20 wt % of inorganic salt relative to the weight of the raw glycerol. Most preferably, said spraying solution comprises 2 wt % to 14 wt % of raw glycerol relative to the total weight of spraying solution, wherein the raw glycerol comprises 65 wt % to 85 wt % glycerol and 2.5 wt % to 15 wt % of inorganic salt relative to the weight of the raw glycerol.

Moreover, a typical method of preparation of said tank mix is provided, which comprises the steps of adding of the following components to the tank:

a) from 19 wt. % to 99 wt. % of water,
b) from 1 wt. % to 20 wt. % of raw glycerol,
c) optionally, from 0.05 to 1 wt. % of adjuvant,
d) from 0.001 to 60 wt. % of agrochemical formulation,
e) optionally, from 0 wt. % to 13 wt. % of oil,
f) water q.s.f. for making up to the capacity of the tank,
the percentage by weight of each ingredient being relative to the total weight of the composition, in which stages (b), (c), (d) and (e) can be carried out in any order. The term “q.s.f” means “quants sats para”, i.e. that a compound is added in a quantity to complete a certain quantity (e.g. the capacity of a tank) to 100%.

In another preferred embodiment, the method for the preparation of the spraying solution comprises the steps of adding water, raw glycerol and agrochemical composition to a tank. In another preferred embodiment, a method for preparation of a spraying solution is provided, wherein raw glycerol is added to the spraying solution at 1 to 40 wt %, preferably 1 to 30 wt %, more preferably 1 to 25 wt %, even more preferably 1 to 20 wt %, especially 3 to 30 wt %, more especially 5 to 20 wt %, relative to the total weight of the spraying solution. In another preferred embodiment, the raw glycerol is added to the spraying solution at least at 0.5 wt %, preferably at least 1.0 wt %, more preferably at least 5.0 wt %, even more preferably at least 10 wt %, especially at least 15 wt %, more especially at least 19 wt %, relative to the total weight of the spraying solution

The amount of water must comply with the recommendations of the equipment that is to be used. Often, the spraying solution is applied in an amount of 5 to 600 liters per hectare (L/ha). Preferably, a low-volume system or a “normal” volume system may be used, more preferably a low-volume system is used. In the low-volume system with aerial equipment, the application rate of the spraying solution is usually from 5 to 15 liters per hectare. For terrestrial spraying, application rate for the low-volume variant is usually 15 to 30 liters per hectare, demonstrating a considerable reduction in volume of water, in comparison with conventional methods. The variation in the rate of agrochemical composition must be according to the manufacturer's instructions and good agricultural practice. Larger volume systems may only have glycerol as additive, without the need for vegetable oil. They are preferably applied at a rate from 100 L/ha to 600 L/ha.

Typically, in low-volume aerial applications, a dose from 5 to 15 liters per hectare is applied, with flying altitude from 2 to 3 meters from the target, application strip of 12 to 15 meters and nozzle angle of 90° relative to the direction of flight, with application only in favorable environmental conditions, avoiding overlap of spraying strips during application and in conditions of wind speed below 10 km per hectare.

In another preferred embodiment the doses for aerial application are:
5 to 40 liters q.s.f. of water per hectare (“high dosage”), preferably 5 to 15 liters q.s.f. of water per hectare (“low dosage”),
0.05 to 4 liters per hectare raw glycerol for high dosage, preferably 1 to 4 liters per hectare for low dosage,
0 to 5.0 liters of vegetable oil per hectare for high dosage, preferably 0.5 to 2.0 liters per hectare of vegetable oil for low dosage,
0.003 to 0.4 liters or kg of adjuvant per hectare for high dosage, preferably 0.013 to 0.2 liters or kg of adjuvant per hectare for low dosage,
0.003 liters or kg to 6 L or kg of agrochemical composition per hectare for high dos-age, preferably 0.1 to 3 liters or kg per hectare for low dosage.

In another preferred embodiment the doses for terrestrial application are:
15 to 600 liters water q.s.f. per hectare (“high dosage), preferably 15 to 30 liters q.s.f. of water per hectare (“low dosage”),
0.15 to 24 liters per hectare raw glycerol for high dosage, preferably 1 to 4 liters per hectare for low dosage,
0 to 2 liters vegetable oil per hectare for high dosage, preferably 0.5 to 2.0 liters per hectare for low dosage,
0.038 to 6.0 liters adjuvants per hectare for high dosage, preferably 0.038 to ap-proximately 0.15 L/ha for low dosage,
0.003 to approximately 6 L or kg per hectare agrochemical composition for high dosage, preferably 0.1 to approximately 3.0 liters per hectare for low dosage.

The common types of equipment are those specific to treatments by aerial agricultural spraying for application of 5 to 40 liters of spraying solution per hectare, preferably equipment with high performance in productivity and accuracy for application of 5 to 15 liters of solution volume per hectare. For terrestrial application, equipment is used for the application of 15 to 600 liters of solution volume per hectare, preferably spraying equipment of the self-propelled type for application of low volume of 15 to 30 liters per hectare.

The time of application of the agricultural treatment with glycerol should comply with the recommendation of the agrochemical, herbicides for control of weeds, fungicides for control of diseases, insecticides and acaricides for pest control, plant growth regulators for better performance in harvesting or in the application of foliar fertilizers for correcting nutritional deficiencies of plants.

The agricultural treatments in which the method can be applied are all those that involve agricultural cultivation, as well as in treatments in nonagricultural uses. The agricultural treatments can be applied on agricultural crops with an annual cycle, such as soybean (Glycine max), cotton (Gossypium hirsutum), haricot bean (Phaseolus spp), pea (Pisum sativum), groundnut (Arachis hypogaea), legumes, maize (Zea mays), rice (Oryza sativa), grain sorghum (Sorghum bicolor), wheat (Triticum aestivum), millet (Pennisetum glaucum), rye (Secale cereale), barley (Hordeum vulgare), sugarcane (Saccharum officinarum), sunflower (Helianthus annuus), canola (Brassica rapa), potato (Solanum tuberosum), chili pepper (Capsicum annuum), onion (Allium cepa), garlic (Allium sativum), carrot (Daucus carota) or other crops with a perennial cycle, such as citrus species (Citrus spp.), coffee (Coffeea arabica), banana (Musa spp.), apple (Malus spp), pear (Pyrus spp), peach (Prunus persica), nectarine (Prunus persica/nusipersica), grape (Vitis spp.), persimmon (Diospyros kaki), mango (Mangifera indica), forestry crops, such as pine (Pinus spp.), eucalyptus (Eucalyptus spp.), acacia (Acacia mearnsii), rubber (Hevea brasiliensis), oil palm (Elaeis guineensis N.).

Preferably, the method can be used on crops of soybean (Glycine max), cotton (Gossypium hirsutum), maize (Zea mays), sugarcane (Saccharum officinarum), banana (Musa spp.) and sunflower (Helianthus annuus). The nonagricultural uses can be on highways, railroads, industrial areas and urban areas.

The term “pesticide” within the meaning of the invention states that one or more compounds can be selected from the group consisting of fungicides, insecticides, nematicides, herbicide and/or safener or growth regulator. Also mixtures of pesticides of two or more the aforementioned classes can be used. The skilled artisan is familiar with such pesticides, which can be, for example, found in the Pesticide Manual, 13th Ed. (2003), The British Crop Protec-tion Council, London.

The herbicides include the chemical group, for example aryloxyalkanoic acid, aryloxy-phenoxypropionic acid, pyridinyloxyalkanoic acid, pyridinocarboxylic acid, pyrimidinyloxybenzoic acid, quinolinocarboxylic acids, analog of pyrimidinyloxybenzoic acid, anilides, bipyridyls, cyclohexenedicarboximide, diphenyl ether, N-phenylphthalimides, substituted glycine, substituted homoalanine, imidazolinones, isoxazolidinones, cyclohexanedione oximes, sulfonylureas, triazines, triazinones, triazolinones, triazolones, uracils, ureas, pyrazolones, pyrimidiones, phenyl uracil, pyrimidinylthiobenzoate, triazolopyrimidines, dinitroanilines, pyridazines, pyridazinones, nicotinanilides, phenoxies, benzoic acids, carboxylic acids, semi-carbazones, benzothiadiazoles, phenylpyridazines, starches, thiocarbamates, triazoles, diphenylethers, oxadiazoles, chloroacetamides, acetamides, oxyacetamides, bipyridyls, triketones, pyrazoles, isoxazoles, benzoylisoxazole.

In a preferred embodiment, the herbicide is selected from the group consisting of
acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenylchlor;
amino acid derivatives: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
Bipyridyls: diquat, paraquat;
(thio)carbamates: asulam, butylate, carbetamide, desmedipham, dimepiperate, eptam (EPTC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bomoxynil, dichiobenil, ioxynil;
imidazolinones: imazamethabenz, imazamox, imazapic, imazapyr, imazaquin, imazethapyr;
phenoxy acetic acids: clomeprop, 2,4-dichlorophenoxyacetic acid (2,4-D), 2,4-DB, dichlorprop, MCPA, MCPA-thioethyl, MCPB, Mecoprop;
pyrazines: chloridazon, flufenpyr-ethyl, fluthiacet, norflurazon, pyridate;
pyridines: aminopyralid, clopyralid, diflufenican, dithiopyr, fluridone, fluoroxypyr, picloram, picolinafen, thiazopyr;
sulfonyl ureas: amidosulfuron, azimsulfuron, bensulfuron, chiorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;
triazines: ametryn, atrazine, cyanazine, dimethametryn, ethiozin, hexazinone, metamitron, metribuzin, prometryn, simazine, terbuthylazine, terbutryn, triaziflam;
ureas: chlorotoluron, daimuron, diuron, fluometuron, isoproturon, linuron, methabenzthiazuron, tebuthiuron;
other acetolactate synthase inhibitors: bispyribac-sodium, cloransulam-methyl, diclosulam, florasulam, flucarbazone, flumetsulam, metosulam, ortho-sulfamuron, penoxsulam, propoxycarbazone, pyribambenz-propyl, pyribenzoxim, pyriftalid, pyrimi-nobacmethyl, pyrimisulfan, pyrithiobac, pyroxasulfone, pyroxsulam;
others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethlyl, chiorthal, cinmethylin, clomazone, cumyluron, cyprosulfamide, dicamba, difenzoquat, diflufenzopyr, endothal, ethofumesate, etobenzanid, fentrazamide, flumiclorac-pentyl, flumioxazin, flupoxam, fluorochloridone, flurtamone, indanofan, isoxaben, isoxaflutole, lenacil, propanil, propyzamide, quinclorac, quinmerac, mesotrione, methyl arsonic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, sulcotrione, sulfentrazone, terbacil, tefuryltrione, tembotrione, thiencarbazone, topramezone, 4-hydroxy-3-[2-(2-methoxy-ethoxymethyl)-6-trifluoromethyl-pyridine-3-carbonyl]-bicyclo[3.2.1]oct-3-en-2-one, (3-[2-chloro-4-fluoro-5-(3-methyl-2,6-dioxo-4-trifluoromethyl-3,6-dihydro-2H-pyrimidin-1-yl)-phenoxy]-pyridin-2-yloxy)-acetic acid ethyl ester, 6-amino-5-chloro-2-cyclopropyl-pyrimidine-4-carboxylic acid methyl ester, 6-chloro-3-(2-cyclopropyl-6-methyl-phenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester, phenyl uracils, such as saflufenacil, butafenacil, flupropacil.

Preferably, herbicides derived from the chemical group of phenyl uracil, substituted glycine and imidazolinones are used. In another preferred embodiment, herbicides derived from the chemical group of phenyl uracils, amino acid derivatives and imidazolinones are used.

The fungicides include chemical groups of fungicides, for example alkylenobis (dithiocarbamates), analog of triazole, benzimidazoles, benzimidazoles, dicarboximides, strobilurines, phthalides, guanidines, imidazoles, isophthalonitriles, morpholines, oxazolidinediones, quinones, triazoles, imidazoles, piperazines, pyridines, pyrimidines, oxazolidinones, butyrolactones, piperidines, spiroketalamines, anilides, pyrimidines, acylamines, anilinopyrimidines, diethofencarb, Diethophencarb, phenylpyrroles, cinnamic acid, reductase inhibitors, dehydratase inhibitors, hydroxyanilide, antibiotics, polyoxine, benzothiadiazoles, amino acid, starch, carbamates, cyanoacetamide oxime, organotins, inorganic dithiocarbamates and related compounds, phthalimide, chloronitriles, sulfamide, guanidines, triazines, phenylpyridinamines, quinoxalines.

In a preferred embodiment, the fungicide is selected from the group consisting of

A) strobilurins
azoxystrobin, dimoxystrobin, enestroburin, fluoxastrobin, kresoxim-methyl, meto-minostrobin, orysastrobin, picoxystrobin, pyraclostrobin, pyribencarb, trifloxystrobin, 2-(2-(6-(3-chloro-2-methyl-phenoxy)-5-fluoro-pyrimidin-4-yloxy)-phenyl)-2-methoxy-imino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-di-chlorophenyl)-1-methyl-allylideneaminooxymethyl)-phenyl)-2-methoxyimino-N-methyl-acetamide;
   B) carboxamides
carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penthiopyrad, tecloftalam, thifluzamide, tiadinil, 2-amino-4-methyl-thiazole-5-carboxanilide, 2-chloro-N-(1,1,3-trimethyl-indan-4-yl)-nicotinamide, N-(2′,4′-difluorobiphenyl-2-yl)-3-difluoromethyl-1-methyl-1H-pyrazole-4-carboxamide, N-(2′,4′-dichlorobiphenyl-2-yl)-3-difluoromethyl-1-methyl-1H-pyrazole-4-carboxamide, N-(2′,5′-difluorobiphen-yl-2-yl)-3-difluoromethyl-1-methyl-1H-pyrazole-4-carboxamide, N-(2′,5′-dichloro-biphenyl-2-yl)-3-difluoromethyl-1-methyl-1H-pyrazole-4-carboxamide, N-(3′,5′-di-fluorobiphenyl-2-yl)-3-difluoromethyl-1-methyl-1H-pyrazole-4-carboxamide, N-(3′-fluorobiphenyl-2-yl)-3-difluoromethyl-1-methyl-1H-pyrazole-4-carboxamide, N-(3′-chlorobiphenyl-2-yl)-3-difluoromethyl-1-methyl-1H-pyrazole-4-carboxamide, N-(Z-fluorobiphenyl-2-yl)-3-difluoromethyl-1-methyl-1H-pyrazole-4-carboxamide, N-(2′-chlorobiphenyl-2-yl)-3-difluoromethyl-1-methyl-1H-pyrazole-4-carboxamide, N-(3′,5′-dichlorobiphenyl-2-yl)-3-difluoromethyl-1-methyl-1H-pyrazole-4-carboxamide, N-(3′,4′,5′-trifluorobiphenyl-2-yl)-3-difluoromethyl-1-methyl-1H-pyrazole-4-carboxamide, N-(2′,4′,5′-trifluorobiphenyl-2-yl)-3-difluoromethyl-1-methyl-1H-pyrazole-4-carboxamide, N-[2-(1,1,2,3,3,3-hexafluoropropoxy)-phenyl]-3-difluoro-methyl-1-methyl-1H-pyrazole-4-carboxamide, N-[2-(1,1,2,2-tetrafluoroethoxy)-phenyl]-3-difluoromethyl-1-methyl-1H-pyrazole-4-carboxamide, N-(4′-trifluoromethyl-thiobiphenyl-2-yl)-3-difluoromethyl-1-methyl-1H-pyrazole-4-carboxamide, N-(2-(1,3-dimethyl-butyl)-phenyl)-1,3-dimethyl-5-fluoro-1H-pyrazole-4-carboxamide, N-(2-(1,3,3-trimethyl-butyl)-phenyl)-1,3-dimethyl-5-fluoro-1H-pyrazole-4-carboxamide, N-(4′-chloro-3′,5′-difluoro-biphenyl-2-yl)-3-difluoromethyl-1-methyl-1H-pyrazole-4-carboxamide, N-(4′-chloro-3′,5′-difluoro-biphenyl-2-yl)-3-trifluoromethyl-1-methyl-1H-pyrazole-4-carboxamide, N-(3′,4′-dichloro-5′-fluoro-biphenyl-2-yl)-3-trifluoromethyl-1-methyl-1H-pyrazole-4-carboxamide, N-(3′,5′-difluoro-4′-methyl-biphenyl-2-yl)-3-difluoromethyl-1-methyl-1H-pyrazole-4-carboxamide, N-(3′,5′-difluoro-4′-methyl-biphenyl-2-yl)-3-trifluoromethyl-1-methyl-1H-pyrazole-4-carboxamide, N-(2-bicyclopropyl-2-yl-phenyl)-3-difluoromethyl-1-methyl-1H-pyrazole-4-carboxamide, N-(cis-2-bicyclopropyl-2-yl-phenyl)-3-difluoromethyl-1-methyl-1H-pyrazole-4-carboxamide, N-(trans-2-bicyclopropyl-2-yl-phenyl)-3-difluoromethyl-1-methyl-1H-pyrazole-4-carboxamide, N-[1,2,3,4-tetrahydro-9-(1-methylethyl)-1,4-methano-naphthalen-5-yl]-3-(difluoromethyl)-1-methyl-1H-pyrazole-4-carboxamide;
carboxylic morpholides: dimethomorph, flumorph;
benzoic acid amides: flumetover, fluopicolde, fluopyram, zoxamide, N-(3-Ethyl-3,5,5-trimethyl-cyclohexyl)-3-formylamino-2-hydroxy-benzamide;
other carboxamides: carpropamid, dicyclomet, mandiproamid, oxytetracyclin, silthiofarm and N-(6-methoxy-pyridin-3-yl)cyclopropanecarboxylic acid amide;
   C) azoles
triazoles: azaconazole, bitertanol, bromuconazole, cyproconazole, difenoconazole, diniconazole, diniconazole-M, epoxiconazole, fenbuconazole, fluquinconazole, flusi-lazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, 1-(4-chloro-phenyl)-2-([1,2,4]triazol-1-yl)cycloheptanol;
imidazoles: cyazofamid, imazalil, pefurazoate, prochloraz, triflumizol;
benzimidazoles: benomyl, carbendazim, fuberidazole, thiabendazole;
others: ethaboxam, etridiazole, hymexazole and 2-(4-chloro-phenyl)-N-[4-(3,4-di-methoxy-phenyl)-isoxazol-5-yl]-2-prop-2-ynyloxy-acetamide;
   D) heterocyclic compounds
pyridines: fluazinam, pyrifenox, 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine, 2,3,5,6-tetra-chloro-4-methanesulfonyl-pyridine, 3,4,5-trichloropyridine-2,6-di-carbonitrile, N-(1-(5-bromo-3-chloro-pyridin-2-yl)-ethyl)-2,4-dichloronicotinamide, N-[(5-bromo-3-chloro-pyridin-2-yl)-methyl]-2,4-dichloro-nicotinamide;
pyrimidines: bupirimate, cyprodinil, diflumetorim, fenarimol, ferimzone, mepanipyrim, nitrapyrin, nuarimol, pyrimethanil;
piperazines: triforine;
pyrroles: fenpiclonil, fludioxonil;
morpholines: aldimorph, dodemorph, dodemorph-acetate, fenpropimorph, tride-morph;
piperidines: fenpropidin;
dicarboximides: fluoroimid, iprodione, procymidone, vinclozolin; non-aromatic 5-membered heterocycles: famoxadone, fenamidone, octhilinone, probenazole, 5-amino-2-isopropyl-3-oxo-4-ortho-tolyl-2,3-dihydro-pyrazole-1-carbothioic acid S-allyl ester;
others: acibenzolar-5-methyl, amisulbrom, anilazin, blasticidin-S, captafol, captan, chinomethionat, dazomet, debacarb, diclomezine, difenzoquat, difenzoquat-methyl-sulfate, fenoxanil, Folpet, oxolinic acid, piperalin, proquinazid, pyroquilon, quin-oxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole, 5-chloro-7-(4-methyl-piperidin-1-yl)-6-(2,4,6-trifluorophenyl)-[1,2,4]triazolo[1,5-a]pyrimidine, 6-(3,4-di-chloro-phenyl)-5-methyl-[1,2,4]triazolo[1,5-a]pyrimidine-7-ylamine, 6-(4-tert-butyl-phenyl)-5-methyl-[1,2,4]triazolo[1,5-a]pyrimidine-7-ylamine, 5-methyl-6-(3,5,5-tri-methyl-hexyl)-[1,2,4]triazolo[1,5-a]pyrimidine-7-ylamine, 5-methyl-6-octyl-[1,2,4]-tri-azolo[1,5-a]pyrimidine-7-ylamine, 6-methyl-5-octyl-[1,2,4]triazolo[1,5-a]pyrimidine-7-ylamine, 6-ethyl-5-octyl-[1,2,4]triazolo[1,5-a]pyrimidine-7-ylamine, 5-ethyl-6-octyl-[1,2,4]triazolo[1,5-a]pyrimidine-7-ylamine, 5-ethyl-6-(3,5,5-trimethyl-hexyl)-[1,2,4]-tri-azolo[1,5-a]pyrimidine-7-ylamine, 6-octyl-5-propyl-[1,2,4]triazolo[1,5-a]pyrimidine-7-ylamine, 5-methoxymethyl-6-octyl-[1,2,4]triazolo[1,5-a]pyrimidine-7-ylamine, 6-octyl-5-trifluoromethyl-[1,2,4]triazolo[1,5-a]pyrimidine-7-ylamine and 5-trifluoro-methyl-6-(3,5,5-trimethyl-hexyl)-[1,2,4]triazolo[1,5-a]pyrimidine-7-ylamine;
   E) carbamates
thio- and dithiocarbamates: ferbam, mancozeb, maneb, metam, methasulphocarb, metiram, propineb, thiram, zineb, ziram;
carbamates: benthiavalicarb, diethofencarb, flubenthiavalicarb, iprovalicarb, propamocarb, propamocarb hydrochlorid, valiphenal and N-(1-(1-(4-cyano-phenyl)-ethanesulfonyl)-but-2-yl) carbamic acid-(4-fluorophenyl)ester;
   F) other active substances
guanidines: guanidine, dodine, dodine free base, guazatine, guazatine-acetate, iminoctadine, iminoctadine-triacetate, iminoctadine-tris(albesilate);
antibiotics: kasugamycin, kasugamycin hydrochloride-hydrate, streptomycin, polyoxine, validamycin A;
nitrophenyl derivates: binapacryl, dinobuton, dinocap, nitrthal-isopropyl, tecnazen, organometal compounds: fentin salts, such as fentin-acetate, fentin chloride or fentin hydroxide;
sulfur-containing heterocyclyl compounds: dithianon, isoprothiolane;
organophosphorus compounds: edifenphos, fosetyl, fosetyl-aluminum, iprobenfos, phosphorous acid and its salts, pyrazophos, tolclofos-methyl;
organochlorine compounds: chlorothalonil, dichlofluanid, dichlorophen, flusulfamide, hexachlorobenzene, pencycuron, pentachlorphenole and its salts, phthalide, quintozene, thiophanate-methyl, tolylfluanid, N-(4-chloro-2-nitro-phenyl)-N-ethyl-4-methyl-benzenesulfonamide;
inorganic active substances: Bordeaux mixture, copper acetate, copper hydroxide, copper oxychloride, basic copper sulfate, sulfur;
others: biphenyl, bronopol, cyflufenamid, cymoxanil, diphenylamin, metrafenone, mildiomycin, oxin-copper, prohexadione-calcium, spiroxamine, tolylfluanid, N-(cyclo-propylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethyl-silanyl-propoxy)-phenyl)-N-ethyl-N-methyl formamidine and N′-(5-difluoromethyl-2-methyl-4-(3-trimethylsilanyl-propoxy)-phenyl)-N-ethyl-N-methyl formamidine.

Preferably, fungicides of the chemical group of the triazoles and strobilurines are used.

The insecticides include chemical groups, for example analog of pyrazole, avermectin, substituted benzoylurea, chlorinated cyclodienes, chlorodiphenylsulfone, synthetic pyrethroids, pyrethrins, organotin (organotin matricides), pyridazinone, thiadiazinone, thiazolidinecarboxamide, carbamates, organophosphates, phenylpyrazoles, diphenylethanes, chloronicotines, cartap, bensultap, spinosyns, avermectin, milbemycin, endocrine disruptors (pimetrozine, cryolite), pyrrole compound, ester sulfite matricides, triazine, benzoic acid, hydrazide, triazapentadiene.

In a preferred embodiment, the insecticide is selected from the group consisting of
organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, suiprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
nicotinic receptor agonists/antagonists compounds: clothianidin, dinotefuran, imidacloprid, thiamethoxam, nitenpyram, acetamiprid, thiacloprid, 1-(2-chloro-thiazol-5-ylmethyl)-2-nitrimino-3,5-dimethyl-[1,3,5]triazinane;
GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioic acid amide;
macrocyclic lactone insecticides: abamectin, emamectin, milbemectin, lepimectin, spinosad, spinetoram;
mitochondrial electron transport inhibitor (METI) I acaricides: fenazaquin, pyridaben, tebufenpyrad, tolfenpyrad, flufenerim;
METI II and III compounds: acequinocyl, fluacyprim, hydramethylnon;
Uncouplers: chlorfenapyr;
oxidative phosphorylation inhibitors: cyhexatin, diafenthiuron, fenbutatin oxide, propargite;
moulting disruptor compounds: cryomazine;
mixed function oxidase inhibitors: piperonyl butoxide;
sodium channel blockers: indoxacarb, metaflumizone;
   others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluoron, and pyrifluquinazon. Preferably, the insecticides is a pyrethroid, benzoylurea or pyrazole. In another preferred embodiment, the insecticides is a pyrethroid, benzoylurea or GABA antagonist compound.

The acaricide is selected from the group consisting of pyrazole, avermectin, benzoylurea, chlorinated cyclodiene, chlorodiphenylsulfone, pyrethroid ester, organotin, pyridazonone, thiadiazinone, thiazolidinecarboxamide. Preferably, benzoylurea, organotin and analog of pyrazole are used.

Examples of growth regulators are abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (pro-hexadione-calcium), prohydrojasmon, thidiazuron, triapenthenol, tributyl phosphorotrithioate, 2,3,5-tri-iodobenzoic acid, trinexapac-ethyl and uniconazol.

The agricultural treatments with herbicides include the control of broad-leaved weeds, for example the main species of economic importance, such as Ipomoea spp., Commelina spp., Tridax procumbens, Euphorbia spp., Sida spp, Bidens spp., Galinsoga spp, Solanum spp.; Xanthium spp, Chenopodium spp., Spermacoce latifolia, Richardia brasiliensis, Sonchus oleraceous, Conyza spp., Amaranthus spp., Acanthospermum spp., Hyptis spp. Portulaca oleracea, Cassia obtusifolia, also comprising the control of cyperaceae, species of Cyperus spp., as well as gramineous species, such as Brachiaria spp., Digitaria spp., Panicum spp., Setaria spp., Sorghum halepense, Echinochloa spp., Eleusine indica, Pennisetum spp. and other species of weeds that have increased in importance owing to harmful competition with crops. Preferably, there is control of Ipomoea spp., Euphorbia heterophylla, Echinochloa spp. and Cassia obtusifolia,

The agricultural treatments with insecticides include the control of insects by foliar treatment, for example pests of the species Anticarsia gemmatalis and Pseudoplusia includens that cause damage to soya, Spodoptera frugiperda that causes damage to maize, Alabama argillacea, Pectinophora gossypiella and Heliothis virescens, Anthonomus grandis, Thrips spp, Aphis gossypii that cause damage to cotton crops, Leucoptera coffeella that causes damage to coffee crops, Neoleucinodes elegantalis that causes damage to tomato crops, Diabrotica speciosa and Epicauta atomaria that cause damage to cotton crops. Preferably, insecticides for the control of Anticarsia gemmatalis, Pseudoplusia includens, Spodoptera frugiperda, Heliothis virescens and Aphis gossypii are used.

The agricultural treatments with acaricides include the control of mites, for example Phyllocoptruta oleivora, Brevipalpus phoenicis, Polyphagotarsonemus latus, Panonychus citri, Eutetranychus banksi that cause damage to citrus crops, Polyphagotarsonemus latus, Tetranychus urticae that cause damage to cotton crops. Preferably, acaricides are used for the control of Phyllocoptruta oleivora, Brevipalpus phoenicis and Polyphagotarsonemus latus.

The agricultural treatments with fungicides include the control of fungi diseases, for example Phakopsora packyrhizi, Corynespora cassiicola, Septoria glycines, Cercospora kikuchii, Microsphaera diffusa that cause damage to soya crops, Septoria tritici, Leptosphaeria nodorum, Bipolaris sorokiniana, Puccinia recondita, Drechslera triticirepentis that cause damage to wheat crops, Puccinia polysora, Phaeosphaeria maydis that cause damage to maize crops, Colletotrichum gossypii and Ramularia areola that cause damage to cotton crops, Alternaria porri and Puccinia allii that cause damage to garlic crops, Cercospora arachidicola and Phaeoisariopsis personata that cause damage to groundnut crops, Puccinia coronata var. avenae that causes damage to oat crops, Mycosphaerella musicola and Mycosphaerella fijiensis that cause damage to banana crops, Alternaria solani that causes damage to potato crops, Hemileia vastatrix, Cercospora coffeicola that causes damage to coffee crops, Alternaria porri and Peronospora destructor that causes damage to onion crops, Alternaria dauci that causes damage to carrot crops, Elsinoe australis and Phyllostica citricarpa that cause damage to citrus crops, Puccinia horiana that causes damage to chrysanthemum crops, Phaeoisariopsis griseola, Colletotrichum lindemuthianum, Uromyces appendiculatus that cause damage to bean crops, Venturia inaequalis and Colletotrichum gloeosporioides that cause damage to apple crops, Colletotrichum gloeosporioides and Oidium mangerifae that cause damage to mango crops. Preferably, Phakopsora packyrhizi, Septoria tritici, Mycosphaerella musicola and Mycosphaerella fijiensis, and Hemileia vastatrix, Colletotrichum gossypii and Ramularia areola are controlled.

In another preferred embodiment, the use of raw glycerol derived from the production of biodiesel in the preparation of a spraying solution, which comprises at least one agrochemical composition, is disclosed. Typically, the raw glycerol comprises at least 1 wt % of an inorganic salt. The raw glycerol may be mixed with vegetable and/or mineral oil. The spraying solution may be applied in an amount of 5 to 15 L/ha by aerial spraying or in an amount of 15 to 30 L/ha by terrestrial spraying.

### ADVANTAGES

The invention creates extensive large-scale uses of the glycerol from biodiesel manufacturing for use in agricultural treatments, both in aerial treatments by means of agricultural aircraft, and in terrestrial treatments, preferably in applications with low spraying volume of solution, principally as an alternative to the use of vegetable oil, the consumption of which has increased in this application. One of the advantages of the method of agricultural treatment with the use of the “Glycerol for Agricultural Spraying (GAS)” technology, with glycerol obtained from biodiesel manufacture, is the proximity to the agricultural areas, with easy transport at low cost for the farmers in the region. Another benefit is the alternative use of this surplus glycerol so as to prevent unsuitable discharge of the derivative in the environment, or the proper discharge at a cost that makes the production of biodiesel less attractive, which has become the most important alternative biofuel from renewable resources, reducing the production of gases in the environment, and thus reducing the greenhouse effect. In this specific case, the inventors also have the objective of obtaining carbon credits when a more polluting product is substituted, or ultimately reducing the emission of toxic gases and thus permitting the economic viability of this projected use of glycerol in the countries listed in Annex I or Annex II of the Kyoto Protocol.

The results of the method demonstrated that the glycerol replaced the use of vegetable oil partly or completely, preferably used with low volumes of spraying solution, optimizing the applications of this form with low cost and good performance, reducing the volume of vegetable oil by ⅓ or completely. In this form of application, the required volume of water in the solution is reduced by at least 50%, that is, for each 1000 liters of water there will be a saving of at least 500 liters. In the form of application of low volume of solution or Low Oil Volume (LOV), when vegetable oil is used, the volume of solution to be sprayed is from 5 to 15 liters per hectare, and in terrestrial applications by tractor, the volume of spraying solution in question is from 15 to 30 liters, in comparison with the normal volumes of 100-200 liters of water. With the new method according to the invention of “Glycerol for Agricultural Spraying (GAS)”, the water requirement is greatly reduced, being 5 to 13 times less compared with the normal conventional system. With the new technique, the farmer will benefit from the greater availability of glycerol, principally for farmers forming part of the biodiesel production chain.

The method of the invention improves the performance of agricultural treatments with reduction of application volume, reduction of surface tension and increase in wettability of the spraying solution based on the technology using glycerol for agricultural spraying. Another advantage is reduction of the glycerol purification stage; required for industrial use, glycerol for agricultural treatment reduces this stage which is carried out once or twice, depending on the industrial use, thus reducing costs and processes.

The main agricultural treatments with greatest range of agricultural use were identified. For this, procedures were elaborated for evaluating the agronomic efficiency of agricultural treatments for the control of weeds using herbicides; this form represents more than 30 million hectares of agricultural crops, besides the agricultural treatments for the control of diseases of soybean rust, which is one of the greatest agricultural problems in the cultivation of soya in Brazil and in various other countries. A procedure was also elaborated for testing the feasibility of the method for various crops, such as cotton, haricot bean, maize, wheat and sorghum. Both the crops tested and the biological targets were selected on the basis of greatest agricultural importance and representativeness for the farmers. The field tests that demonstrate the efficacy of the method with glycerol are described in the examples given below, but this does not limit the scope of the invention.

### EXAMPLES

DASH: A spray tank adjuvant mixture comprising petroleum hydrocarbons, alkyl esters and acids, anionic surfactants. It comprises approximately 37.5 wt % mixed fatty acid methyl esters and 27.5 wt % of a surfactant blend. It is commercially available from BASF SE as DASH® HC.
Glycerol: A raw glycerol derived from the processing of biodiesel from soybean oil, comprising 80 wt. % glycerol, 10 wt. % sodium chloride, 0.20 wt. % methanol and 7 wt. % moisture (10 wt. % ash).
Alteza®: A herbicidal agrochemical composition containing 30 g/L imazethapyr, and 177.8 g/L glyphosate, in the formulation of soluble concentrate (commercially available from BASF SE).
Saflufenacil: A herbicidal agrochemical composition containing 120 g/L saflufenacil, in the formulation of emulsifying concentrate.
Vegetable oil: degummed oil obtained from the soybean at 98.7% purity.
Agral®: A nonionic surfactant containing 600 g/L of ethoxylated nonylphenol in a soluble concentrated formulation (commercially available from Syngenta).
Glyphosate: A herbicidal agrochemical composition containing 360 g/l glyphosate of acid equivalent, soluble concentrate formulation (commercially available from Monsanto as Roundup®).
Aurora®: A agrochemical composition containing 40 wt % of carfentrazone-ethyl, concentrated suspension formulation (commercially available from Syngenta).
Assist®: Adjuvant comprising 83 wt % paraffin base mineral oil and 17 wt % surfactant blend (commercially available from BASF SE).
Flumizin: A herbicidal agrochemical composition containing 500 g/kg flumioxazin, wettable powder.
EPX/PYR188: A fungicidal agrochemical composition 133 g/Lepoxiconazole and 50 g/L pyraclostrobin, formulation of suspo-emulsion (SE) with 29.2 wt % solvent naphtha used at the full recommended dose of 0.5 L/ha.
EPX/PYR144: A fungicidal agrochemical composition containing 80 g/L epoxiconazole and 64.5 g/L pyraclostrobin, suspo-emulsion (SE), used at half the recommended dose of 0.25 L/ha.
EPX: A fungicidal agrochemical composition containing 125 g/L epoxiconazole, concentrated suspension (SC), used at the full recommended dose of 0.4 L/ha.
Fastac® 100 EC/SC: An insecticidal agrochemical composition containing 100 g/L alphacypermethrin, emulsion concentrate (EC) or suspension concentrate (SC), commercially available from BASF SE.
Nomolt®: An insecticidal agrochemical composition containing 150 g/L teflubenzuron, suspension concentrate (SC), commercially available from BASF SE.
Imunit®: An insecticidal agrochemical composition containing 75 g/L teflubenzuron and 75 g/l alphacypermethrin, suspension contentrate (SC), commercially available from BASF SE.
Opera®: An insecticidal agrochemical composition containing 133 g/l Pyraclostrobin and 50 g/l epoxiconazol, commercially available from BASF SE.
Agroleo: An vegetable oil based adjuvant containing 97 wt % soybean oil and an sticking agent from the group of esters (commercially available from Gota Indústria e Comércio as Agr'oléo®).

### Example 1

### Herbicidal Treatment

This example is an experimental test with weeds, illustrating an agricultural treatment for controlling these plants in the desiccation period before annual harvests or desiccation of weeds by directed jet for perennial crops to verify the effect of raw glycerol as adjuvant or coadjuvant in agricultural treatment with herbicides. Moreover, raw glycerol was assessed on its own or combined with vegetable oil in agricultural treatments with herbicides for use in the preplanting desiccation of weeds in the case of annual agricultural crops or in the desiccation of weeds by directed jet for perennial crops.

The experiment was carried out with 11 treatments, 3 repetitions with design of complete randomized blocks of 10×2 m², 20 m² per block and 60 m² per treatment. Spraying was carried out directly on the weeds in field conditions.

The mixture in the tank was prepared in the following steps:
(i) Addition of water, equivalent to 40 liters of water per hectare,
(ii) Doses of Glycerol, equivalent to 2 and 4 liters of Glycerol per hectare,
(iii) Doses of vegetable oil, equivalent to 0.5 to 2.0 liters of vegetable oil per hectare,
(iv) Doses of Dash, equivalent to 0.250 liters of Dash per hectare,
(v) Dose of ALTEZA, equivalent to 2 liters of ALTEZA per hectare,
(vi) Dose of Saflufenacil, equivalent to 0.100 liters of Saflufenacil per hectare, and
(vii) Make up the tank volume with up with water, equivalent to 100 liters spraying solution per hectare.

The containers for the solution for each 60 m² per treatment and each rate of treatment per hectare are presented in Table 1. Treatments 9 and 11 without Glycerol are included as comparison with the treatments with Glycerol to verify the effects of the latter. The equipment used was a CO₂ sprayer mounted on the user's back, using containers of the pet type for each treatment, aluminum spraying bar for spraying with 2 spraying nozzles with spacing of 50 cm, used for experimental tests calibrated for uniform spraying in small portions at 0.15 MPa (1.5 bar) of pressure in the system. The spraying nozzles used were of special type for calibration of 100 liters of solution per hectare. The doses are specified in Table 1. The purpose of the test was for assessing Glycerol and its properties as adjuvant or coadjuvant and/or vegetable oil in normal spraying conditions.

The results in Tables 2 and 3, with the treatments according to Table 1, show that Glycerol alone (treatment 2), or mixed with vegetable oil (treatments 7 and 8), displayed good efficacy, equivalent to or better than 95% of control when used with systemic and contact herbicide in the control of weeds, for example of the species tested Senna obtusifolia and Echinochloa colonum compared with the standard treatments 9 and 11.

The conclusion from the experiment is that raw glycerol possesses properties for use as adjuvant or coadjuvant used in agricultural treatments with herbicides at spraying volumes of 100 liters or larger volumes, the results being considered as similar to the commercial adjuvants, as well as comparison with vegetable oil.

TABLE 1
Treatments

| | L/ha | | | | |
|---|---|---|---|---|---|
| | | | Vegetable | | |
| Treatments | Glycerol | ALTEZA | oil | Saflufenacil | DASH |
| 1** | Control without any treatment | | | | |
| 2 | 4.0 | 2.0 | 0.0 | 0.1 | 0.25 |
| 3 | 2.0 | 2.0 | 0.5 | 0.1 | 0.25 |
| 4 | 2.0 | 2.0 | 1.0 | 0.1 | 0.25 |
| 5 | 2.0 | 2.0 | 1.5 | 0.1 | 0.25 |
| 6 | 3.0 | 2.0 | 0.5 | 0.1 | 0.25 |
| 7 | 3.0 | 2.0 | 1.0 | 0.1 | 0.25 |
| 8 | 3.0 | 2.0 | 1.5 | 0.1 | 0.25 |
| 9** | 0.0 | 2.0 | 2.0 | 0.1 | 0.25 |
| 10 | 4.0 | 2.0 | 0.0 | 0.1 | 0.0 |
| 11** | 0.0 | 2.0 | 2.0 | 0.1 | 0.0 |

**not according to the present invention

The species of weeds were as follows: Ipomoea grandifolia, Euphorbia heterophylla, Cassia obtusifolia and Echinochloa colonum. The method of assessment takes into account the percentage control (0% no control, 100% complete control of weeds) 7 to 30 days after treatment (DAT). The stages of the weeds were as follows:

| Species | Height (cm) |
|---|---|
| Ipomoea grandiflora | 50 cm |
| Euphorbia heterophylla | 50 cm |
| Cassia obtusifolia | 50 cm |
| Echinochloa colonum | 70 cm |

All the plants were in the pre-flowering growth stage and the infestation of each species was 20 weeds per square meter. Experimental design: randomized with 3 repetitions.

Tables 2 and 3 present the results of treatment with Glycerol combined with Alteza and Saflufenacil with addition of Dash at 0.25% v/v and vegetable oil for control of Ipomoea grandifolia, Euphorbia heterophylla, Cassia obtusifolia and Echinochloa colonum at 7 and 30 DAT. At 7 days all the treatments for Ipomoea grandifolia, Euphorbia heterophylla and Echinochloa colonum with Glycerol alone or mixture with vegetable oil with adjuvant or without adjuvant were effective compared with the standard, conventional treatments without Glycerol. For Cassia obtusifolia, Glycerol alone with vegetable oil in treatments 2 and 10 (4.0 L/ha with or without adjuvant), treatment 5 (2.0 L/ha Glycerol+1.5 L/ha oil), treatment 7 (3.0 L/ha Glycerol+1.0 L/ha oil), treatment 8 (3.0 L/ha Glycerol+1.5 L/ha oil) were effective with similar results compared with the reference standards. Similar results were observed 30 days after spraying, when compared with the assessment at 7 days after spraying.

It can be concluded from the results that the use of raw glycerol is similar to the reference standard or conventional treatments for control of Ipomoea grandifolia, Euphorbia heterophylla and Echinochloa colonum, proving that raw glycerol can be used as adjuvant or coadjuvant of agricultural treatments with herbicides for control of weeds.

TABLE 2
Results of control of weeds 7 days after spraying as percentages.

| | | | | | Obser- |
|---|---|---|---|---|---|
| Treat- | Ipomoea | Euphorbia | Cassia | Echinichloa | vation |
| ment | grandifolia | heterophylla | obtusifolia | colonum | day |
| No. | Percentage control of weeds | | | | |
| 1** | 0 | 0 | 0 | 0 | 7 |
| 2 | 100 | 99 | 97 | 99 | 7 |
| 3 | 100 | 99 | 82 | 99 | 7 |
| 4 | 100 | 100 | 88 | 99 | 7 |
| 5 | 100 | 100 | 95 | 99 | 7 |
| 6 | 100 | 99 | 88 | 99 | 7 |
| 7 | 100 | 100 | 95 | 99 | 7 |
| 8 | 100 | 100 | 97 | 100 | 7 |
| 9** | 100 | 99 | 96 | 96 | 7 |
| 10 | 100 | 100 | 93 | 98 | 7 |
| 11** | 100 | 100 | 92 | 98 | 7 |

**not according to the present invention

TABLE 3
Results of control of weeds 30 days after spraying

| | | | | | Obser- |
|---|---|---|---|---|---|
| Treat- | Ipomoea | Euphorbia | Cassia | Echinichloa | vation |
| ment | grandifolia | heterophylla | obtusifolia | colonum | day |
| No. | Percentage control of weeds | | | | |
| 1** | 0 | 0 | 0 | 0 | 30 |
| 2 | 100 | 98 | 96 | 95 | 30 |
| 3 | 100 | 98 | 77 | 83 | 30 |
| 4 | 100 | 98 | 88 | 92 | 30 |
| 5 | 100 | 98 | 93 | 97 | 30 |
| 6 | 100 | 98 | 88 | 92 | 30 |
| 7 | 100 | 98 | 96 | 95 | 30 |
| 8 | 100 | 98 | 98 | 98 | 30 |
| 9** | 100 | 98 | 92 | 90 | 30 |
| 10 | 100 | 98 | 78 | 80 | 30 |
| 11** | 100 | 98 | 87 | 93 | 30 |

**not according to the present invention

### Example 2

### Phytotoxicity

Considering the potential for the use of raw glycerol in agricultural treatments based on the experiment in Example 1, a second experiment was carried out for tests on various crops. This example illustrates the tests relating to the selectivity of raw glycerol on various crops of leguminous and gramineous plants, such as maize (Zea mays), cotton (Gossypium hirsutum), soybean (Glycine max), rice (Oryza sativa), haricot bean (Phaseolus vulgaris) and rye (Triticum aestivum), with the purpose of assessing the feasibility of using raw glycerol on various crops of different species. The purpose of this experiment is to assess the potential for the use of raw glycerol on crops. The experimental design comprised 6 treatments, 3 repetitions and 3 assessments. The species of crops used in the tests were as follows: maize (Zea mays), cotton (Gossypium hirsutum), soybean (Glycine max), rice (Oryza sativa), haricot bean (Phaseolus vulgaris), rye (Triticum sativum). The experiment was carried out with 6 treatments, 3 repetitions with design of complete randomized blocks, of 3×3 m², 9 m² per block and 27 m² per treatment. Spraying was carried out directly on the crops.

The tank mixture was prepared in the following stages: addition of water, equivalent to 20 L of water per hectare, doses of Glycerol, equivalent to 2 and 4 liters of Glycerol per hectare, doses of vegetable oil, equivalent to 0.5 to 2.0 liters of vegetable oil per hectare, dose of Agral, equivalent to 0.25 liters of Agral per hectare and make up the tank volume with water, equivalent to 50 liters spraying solution per hectare. The containers for the solution for each 27 m² per treatment and each dose of treatment per ha are shown in Table 4.

Treatments 4 and 5 without Glycerol are included as comparison with the treatments with Glycerol to verify the effects of this compound. The equipment used was a CO₂ sprayer mounted on the user's back, using containers of the pet type for each treatment, aluminum spraying bar for spraying with 2 spraying nozzles spaced 50 cm apart, used for experimental tests calibrated for uniform spraying in small portions with 0.15 MPa (1.5 bar) of pressure in the system. The spraying nozzles used were of a special type for calibration of 50 liters of solution per hectare. The method of assessment used for assessing selectivity as percentage damage to the crop is presented in Table 5, where 0% denotes no phytotoxic effect on the crop and high selectivity and 100% denotes that the crop was damaged fatally with high phytotoxic effect. Cultivation stage: 4-6 leaves.

TABLE 4
Treatments with different doses of Glycerol
alone or mixed with vegetable oil

| Treatment | Product | Dose in L or kg/ha |
|---|---|---|
| 1** | Verification (control) | — |
| 2 | Glycerol | 2.00 |
| | Agral | 0.25 |
| 3 | Glycerol | 4.00 |
| | Agral | 0.25 |
| 4** | Vegetable oil | 1.50 |
| | Agral | 0.25 |
| 5** | Vegetable oil | 3.00 |
| | Agral | 0.25 |
| 6 | Glycerol | 1.50 |
| | Vegetable oil | 0.75 |
| | Agral | 0.25 |

**not according to the present invention

The results (mean values of the repetitions) of 3 assessments, according to Table 5, demonstrate that raw glycerol can be used on various agricultural crops of various species, being selective for agricultural crops at the doses tested of 2 to 4 liters/ha in foliar spraying on the crops; spraying without any sign of phytotoxicity indicates absence of restriction on spraying of raw glycerol at any frequency. The experiment demonstrated the potential for use of raw glycerol on various crops of leguminous and gramineous plants without any problem of phytotoxicity, contrary to the theory that it can cause damage to crops.

TABLE 5
Selectivity (effect on crops) of treatments with Glycerol compared
with treatments with vegetable oil (Results of 3 assessments performed
07, 14, 21 days after the treatment).

| | Maize | Cotton | Soya | Rice | Haricot bean | Rye |
|---|---|---|---|---|---|---|
| Treatment | Percentage damage to the crops | | | | | |
| 1** | 0 | 0 | 0 | 0 | 0 | 0 |
| 2 | 0 | 0 | 0 | 0 | 0 | 0 |
| 3 | 0 | 0 | 0 | 0 | 0 | 0 |
| 4** | 0 | 0 | 0 | 0 | 0 | 0 |
| 5** | 0 | 0 | 0 | 0 | 0 | 0 |
| 6 | 0 | 0 | 0 | 0 | 0 | 0 |

**not according to the present invention

### Example 3

### Herbicidal Treatment and Phytotoxicity in Citrus Crop

This example illustrates tests of performance of raw glycerol in agricultural treatments on a citrus crop, the purpose of which is to assess the effect of raw glycerol in agricultural treatments at different doses, alone and combined with vegetable oil, on the citrus crop. The experimental design comprised 13 treatments, 3 repetitions with a design of randomized complete blocks and 3 assessments, treatments 5, 6, 9, 10, 11, 12, 13, without Glycerol, included for comparison. The area of the blocks was 10×2 m², and 60 m² per treatment. Spraying was carried out as direct jet, alongside the line of the crop, 1 meter from the left side of the row and then 1 meter from the right side, on the weeds, avoiding contact with the citrus plants. Cultivar: Citrus (Citrus sp.), stage—8 months of age.

The tank mixture was prepared in the following stages: addition of water, equivalent to 40 L of water per hectare, doses of Glycerol, equivalent to 2 to 4 liters of Glycerol per hectare, doses of vegetable oil, equivalent to 0.5 to 2.0 liters of vegetable oil per hectare, dose of Dash, equivalent to 0.250 liters of Dash per hectare, dose of Glyphosate, equivalent to 2 liters of Glyphosate per hectare, dose of Saflufenacil, equivalent to 0.100 liters of Saflufenacil per hectare and make up the tank volume with water equiva-lent to 100 liters spraying solution per hectare.

Other comparison treatments at a dose of AURORA or FLUMIZIN, equivalent to 0.050 liters of AURORA or FLUMIZIN per hectare, at a dose of ASSIST, equivalent to 0.5 liters of ASSIST per hectare. The containers for the solution for each 60 m² per treatment and each rate of treatment per hectare are shown in Table 6. Treatments 9, 10, 11, 12 and 13 without Glycerol are included for comparison with the treatments with Glycerol to verify the effects of this compound.

The equipment used was a CO₂ sprayer mounted on the user's back, using containers of the pet type for each treatment, aluminum spraying bar for spraying with 2 spraying nozzles spaced 50 cm apart, used for experimental tests calibrated for uniform spraying in small portions with 0.15 MPa (1.5 bar) of pressure in the system. The spraying nozzles used were of a special type for calibration of 100 liters of solution per hectare. Assessment of the method of control of weeds employed the percentage control of weeds, with 0% denoting no control of the weeds and 100% denoting total control of the weeds. Assessment of the method of phytotoxicity employed the percentage damage to the citrus crop, where 0% denotes no damage and 100% denotes total damage to the citrus plant.

TABLE 6
Agricultural treatments including the use of Glycerol at various
doses, alone and combined with vegetable oil on the citrus crop.

| | | Dose in L/ha or |
|---|---|---|
| Treatment | Component | kg/ha |
| 1** | — | — |
| 2 | Glycerol | 4.0 |
| | Glyphosate | 2.0 |
| | Saflufenacil | 0.1 |
| | Dash | 0.25 |
| 3 | Glycerol | 2.0 |
| | Glyphosate | 2.0 |
| | Saflufenacil | 0.1 |
| | Dash | 0.25 |
| 4 | Glycerol | 2.0 |
| | Vegetable oil | 1.0 |
| | Glyphosate | 2.0 |
| | Saflufenacil | 0.1 |
| | Dash | 0.25 |
| 5** | Vegetable oil | 1.0 |
| | Glyphosate | 2.0 |
| | Saflufenacil | 0.1 |
| | Dash | 0.25 |
| 6** | Glyphosate | 2.0 |
| | Saflufenacil | 0.1 |
| | Dash | 0.25 |
| 7 | Glyphosate | 2.0 |
| | Glycerol | 4.0 |
| | Dash | 0.25 |
| 8 | Glyphosate | 2.0 |
| | Glycerol | 2.0 |
| | Dash | 0.25 |
| 9 | Glyphosate | 2.0 |
| | Glycerol | 2.0 |
| | Vegetable oil | 1.0 |
| 10** | Glyphosate | 2.0 |
| 11** | Glyphosate | 3.0 |
| 12** | Glyphosate | 2.0 |
| | Carfentrazone | 0.050 |
| | ASSIST | 0.5 |
| 13** | Glyphosate | 2.0 |
| | Flumioxazin | 0.050 |
| | Mineral oil | 0.5 |

**not according to the present invention

The results in Tables 7, 8 and 9 show that Glycerol alone, in the range from 2.0 to 4.0 liters per hectare, or mixed with vegetable oil at a ratio of 2:1 of Glycerol/vegetable oil displayed excellent performance in agricultural treatments with herbicides on the citrus crop (data from 3 repetitions).

In a first assessment 7 days after spraying, treatments 2, 3, and 4 with Glycerol demonstrated superior control, 71-76% of control compared with treatments 5 and 6, 68 and 64% of control, reference standard with vegetable oil or reference standard without vegetable oil; treatments 7 and 8 with Glycerol also demonstrated control similar to the reference standard, demonstrating the potential for use of Glycerol as adjuvant or coadjuvant. In the second assessment 16 days after spraying, the treatments with Glycerol 2, 3 and 4 demonstrated similar or superior control with 93-94% of control, better than treatments 10, 11, 12, 13 with control below 92%, used as reference treatment. In the third assessment, 33 days after spraying, treatments 2, 3, and 4 demonstrated control of 97%, being equal or better compared with reference treatments 5 and 6 with 96% and 97% of control, treatments 7 and 8 with Glycerol, with 92 and 93% of control, were better than the reference treatments 10 and 11, and it can be concluded that raw glycerol, alone or mixed with vegetable oil, is an alternative for an agricultural solution for spraying of herbicides.

TABLE 7
First assessment 7 days after spraying - date: 3 Mar. 2007

| | | Bidens | Lepidium | Digitaria | General |
|---|---|---|---|---|---|
| Treatments | Phytotoxicity | pilosa | virginicum | horizontalis | Control |
| Number of | — | 4 | 2 | 5 | |
| Weeds/m² | | | | | |
| | % damage | % control of weeds | | | |
| 1** | — | — | — | — | — |
| 2 | 0 | 88 | 78 | 62 | 76 |
| 3 | 0 | 82 | 75 | 57 | 71 |
| 4 | 0 | 80 | 75 | 62 | 72 |
| 5** | 0 | 73 | 73 | 58 | 68 |
| 6** | 0 | 68 | 70 | 53 | 64 |
| 7 | 0 | 77 | 70 | 58 | 68 |
| 8 | 0 | 80 | 72 | 55 | 69 |
| 9 | 0 | 80 | 70 | 53 | 68 |
| 10** | 0 | 67 | 67 | 52 | 62 |
| 11** | 0 | 65 | 65 | 50 | 60 |
| 12** | 0 | 75 | 70 | 67 | 71 |
| 13** | 0 | 70 | 70 | 65 | 68 |

**not according to the present invention

TABLE 8
Second assessment 16 days after spraying - date: 12 Mar. 2007

| | | Bidens | Lepidium | Digitaria | General |
|---|---|---|---|---|---|
| Treatments | Phytotoxicity | pilosa | virginicum | horizontalis | Control |
| Number of | — | 7 | 4 | 11 | |
| weeds/m² | | | | | |
| | % damage | % control of weeds | | | |
| 1 | — | — | | — | — |
| 2 | 0 | 98 | 99 | 85 | 94 |
| 3 | 0 | 98 | 99 | 83 | 93 |
| 4 | 0 | 98 | 99 | 83 | 93 |
| 5** | 0 | 99 | 98 | 85 | 94 |
| 6** | 0 | 98 | 98 | 85 | 94 |
| 7 | 0 | 95 | 92 | 84 | 90 |
| 8 | 0 | 94 | 92 | 84 | 90 |
| 9 | 0 | 95 | 93 | 87 | 91 |
| 10** | 0 | 94 | 93 | 83 | 90 |
| 11** | 0 | 93 | 88 | 83 | 88 |
| 12** | 0 | 96 | 92 | 89 | 92 |
| 13** | 0 | 93 | 91 | 89 | 91 |

**not according to the present invention

TABLE 9
Third assessment 33 days after spraying - date: 29 Mar. 2007

| | | Bidens | Lepidium | Digitaria | General |
|---|---|---|---|---|---|
| Treatments | Phytotoxicity | pilosa | virginicum | horizontalis | Control |
| Weeds/m² | — | 11 | 5 | 18 | |
| | % damage | % control of weeds | | | |
| 1 | — | — | — | — | — |
| 2 | 0 | 99 | 99 | 93 | 97 |
| 3 | 0 | 98 | 99 | 95 | 97 |
| 4 | 0 | 99 | 99 | 94 | 97 |
| 5** | 0 | 98 | 99 | 94 | 97 |
| 6** | 0 | 98 | 99 | 92 | 96 |
| 7 | 0 | 95 | 91 | 92 | 93 |
| 8 | 0 | 95 | 90 | 91 | 92 |
| 9 | 0 | 95 | 91 | 92 | 93 |
| 10** | 0 | 93 | 82 | 90 | 88 |
| 11** | 0 | 93 | 90 | 90 | 91 |
| 12** | 0 | 96 | 93 | 93 | 94 |
| 13** | 0 | 95 | 93 | 92 | 93 |

**not according to the present invention

### Example 4

### Fungicidal Treatments on Soybean

This example illustrates an agricultural treatment with fungicides for control of soybean rust (Phakopsora packyrhizi) with raw glycerol, the purpose of which is to assess the effect of raw glycerol as adjuvant or coadjuvant in treatments with fungicides at low volume of 30 liters per hectare. The experiment comprised 10 treatments and 3 repetitions with design or randomized complete blocks. Treatments 2, 3, 8, 9 and 10 without Glycerol are included for comparison. The area of the blocks was 10×2 m², and 60 m² per treatment. Cultivar: soybean (Glycine max). Spraying: 2 applications for each treatment were carried out on 15 Mar. 2007 and 5 Apr. 2007. Assessment: assessment of yield is the principal objective for assessing Glycerol used with fungicides against soybean rust disease (Phakopsora packyrhizi).

The tank mixture was prepared in the following stages: addition of water, equivalent to 15 L of water per hectare, doses of Glycerol, equivalent to 2 and 4 liters of Glycerol per hectare, doses of vegetable oil, equivalent to 0.5 to 2.0 liters of vegetable oil per hectare, dose of Dash per hectare, equivalent to 0.150 liters of Dash per hectare, dose of fungicides, equivalent to 0.25 to 0.5 liters of fungicide per hectare and make up the tank volume with water, equivalent to 30 liters spraying solution per hectare. The container for the solution for each 60 m² per treatment and each rate of treatment per hectare are shown in Table 10.

Treatments 2, 3, 8, 9, and 10 without Glycerol were included for comparison with the treatments with Glycerol to verify the effects of the Glycerol. The equipment used was a CO₂ sprayer mounted on the user's back, using containers of the pet type for each treatment, aluminum spraying bar for spraying with 2 spraying nozzles spaced 50 cm apart, used for experimental tests calibrated for uniform spraying with small jets with 0.15 MPa (1.5 bar) of pressure in this form. The spraying nozzles used were of a special type for calibration of 30 liters of solution per hectare.

TABLE 10
Treatments with fungicides for the control of soybean rust (Phakopsora
packyrhizi) using Glycerol.

| | EPX/PYR144 | Glycerol | Vegetable oil | DASH | EPX/PYR188 | EPX |
|---|---|---|---|---|---|---|
| Treatments | L/ha | L/ha | L/ha | L/ha | L/ha | L/ha |
| 1** | 0 | 0 | 0 | 0 | 0 | 0 |
| 2** | 0.25 | 0 | 0 | 0 | 0 | 0 |
| 3** | 0.25 | 0 | 0 | 0.15 | 0 | 0 |
| 4 | 0.25 | 2.0 | 1.0 | 0 | 0 | 0 |
| 5 | 0.25 | 1.0 | 1.0 | 0 | 0 | 0 |
| 6 | 0.25 | 2.0 | 0 | 0 | 0 | 0 |
| 7 | 0.25 | 4.0 | 0 | 0.15 | 0 | 0 |
| 8** | 0.25 | 0 | 1.0 | 0.15 | 0 | 0 |
| 9** | 0 | 0 | 0 | 0 | 0.5 | 0 |
| 10** | 0 | 0 | 0 | 0 | 0 | 0.4 |

**not according to the present invention

The agricultural treatments with fungicides in which Glycerol was used alone or mixed with vegetable oil showed results having an impact on production, as can be seen in Table 11. The treatments with Glycerol 4, 5, 6, and 7 with fungicide EPX/PYR144, with or without adjuvant, gave a higher yield of 1960 to 2595 kg beans/ha, better than the treatments without Glycerol with EPX/PYR144, 2, 3, and 8 (with vegetable oil), even in treatments 5 and 6 with half the dose they were better than the commercial formulation of full dose of fungicide EPX/PYR188 0.5 L/ha or EPX 0.4 L/ha.

The experiment demonstrated a low volume of terrestrial spraying of 30 liters of solution per hectare, and the potential for use of raw glycerol as adjuvant or coadjuvant in agricultural treatment with fungicides.

TABLE 11
Production results with treatments with fungicides
for control of soybean rust using Glycerol.

| Treatment | Yield (kg beans/ha) |
|---|---|
| 1** | 1215 |
| 2** | 1590 |
| 3** | 1725 |
| 4 | 1960 |
| 5 | 2540 |
| 6 | 2575 |
| 7 | 2595 |
| 8** | 2375 |
| 9** | 2435 |
| 10** | 2165 |

**not according to the present invention

### Example 5

### Physiochemical Properties

In a spraying tank the agrochemical composition, Glycerol and DASH were mixed according to Table 12 and filled up with tap water to a total volume of 10 L. The same mixtures were repeated without the addition of DASH. The resulting solution may be applied in a dose of 10 L/ha.

TABLE 12

| | | Amount of agro- | | |
|---|---|---|---|---|
| | Agrochemical | chemical com- | Amount of | Amount of |
| Sample | composition | position (L) | Glycerin (L) | DASH (L) |
| A | Blank | — | 2.5 | 0.13 |
| B | Alteza | 2.50 | 2.5 | 0.13 |
| C | Round up | 3.00 | 2.5 | 0.13 |
| D | Fastac 100 EC | 0.20 | 2.5 | 0.13 |
| E | Fastac 100 SC | 0.20 | 2.5 | 0.13 |
| F | Nomolt | 0.17 | 2.5 | 0.13 |
| G | Imunit | 0.17 | 2.5 | 0.13 |
| H | Opera | 0.50 | 2.5 | 0.13 |
| I | Saflufenacil + | 0.07 + 3.0 | 2.5 | 0.13 |
| | Glyphosate | | | |

All tank mixes were observed at 1 min, 10 min, 15 min, 60 min and 24 h. The dispersibility of all tank mixes was good. The pH was analyzed of all samples as shown in Table 12A.

TABLE 12A

| Sample | pH with DASH | pH without DASH |
|---|---|---|
| B | 5.99 | 5.94 |
| C | 4.35 | 4.39 |
| D | 2.52 | 4.59 |
| E | 2.66 | 5.22 |
| F | 2.74 | 6.28 |
| G | 2.47 | 6.16 |
| H | 2.60 | 6.28 |
| I | 4.37 | 4.40 |

### Example 6

### Fungicidal Treatment of Soybean

The field trial was designed with 6 treatments and control plot untreated, with 4 repetitions, all treated plots received the fungicide EPX/PYR188 at an application rate of 0.5 L/ha in the emulsified oil adjuvant Agroleo. Some plots additionally were treated with raw glycerol and/or DASH. For details see table 13. The soybean rust control were made in a initial curative condition in all treatments. There were made sequential applications for soybean rust control, with spray solution volume of 70 L/ha, fine droplets, nozzle 11001 and 30 psi of pressure, through costal manual system with constant pressure.

TABLE 13

| | | Volume |
|---|---|---|
| Treatments | Technology | (L/ha) |
| Control Plot | No treatment | — |
| S A | Fungicide + Agroleo | 70 |
| PE 2.5% | 2.5%^{a)} Glycerol + Dash (3% v/v of Glycerol) | 70 |
| PE 5% | 5%^{a)} Glycerol + Dash (3% v/v of Glycerol) | 70 |
| PE 10% | 10%^{a)} Glycerol | 70 |
| PE 5% + | 5%^{a)} Glycerol + Dash (3% v/v of Glycerol) + | 70 |
| OV 2.5% | 2.5%^{a)} Agroleo | |
| OV 5% | 5%^{a)} Agroleo | 70 |

^{a)}wt % relative to the total amount of spraying solution.

The percentage of soybean defoliation was determined 43 days after first application, in soybean stage R5.5. The control plot showed 98%, whereas all treatments showed about 63%. In conclusion, the treatments with raw glycerol show no increase phytotoxicity.

The soybean crop productivity was determined in the control plot at about 30 bags per hectar. All other treatments showed a crop productivity of about 54 bags per hectare. In conclusion, the treatments with raw glycerol showed no negative influence of crop productivity.

### Example 7

### Insecticidal Treatment of Cotton

The field trial were designed with 7 treatments and control plot untreated, with 4 repetitions. All treated plots received insecticide Fastac 100 SC in dose 0.5 L/ha in the emulsified oil adjuvant Agroleo. Some plots additionally were treated with raw glycerol and/or DASH. For details see table 14. Plot measured 6.0 m wide and 10.0 m long. The insecticides application was made in the canopy, approximately 0.5 meters from the plant top, using pressurized (CO₂) backpack sprayer, with spray solution volume of 70 L/ha, fine droplets, 6 nozzles model TJ60 11,002 (nozzle Twinjet) Teejet, spaced in 0.5 m and using 30 psi of pressure through of constant pressure with the backpack sprayer system. The applications were made every 5 days to realize sequential applications to cotton boll weevil control.

TABLE 14

| | | Volume |
|---|---|---|
| Treatments | Technology | (L/ha) |
| Control plot | Control plot without insecticides application | — |
| S A | Without adjuvants | 70 |
| PE 2.5% | 2.5%^{a)} Glycerol + Dash (3% v/v of Glycerol) | 70 |
| PE 5% | 5%^{a)} Glycerol + Dash (3% v/v of Glycerol) | 70 |
| PE 10% | 10%^{a)} Glycerol | 70 |
| PE 5% + | 5%^{a)} Glycerol + Dash (3% v/v of Glycerol) + | 70 |
| OV 2.5% | 2.5%^{a)} Agroleo | |
| OV 5% | 5%^{a)} Agroleo | 70 |

^{a)}wt % relative to the total amount of spraying solution.

For the abnormal bolls (carimãs) evaluation 200 boll structures were evaluated in three cotton plants in harvest period it was observed that there was no statistical difference between treatments and control plot in abnormal bolls number. In conclusion, the treatments of raw glycerol showed no negative effect on cotton bolls.

Further preferred embodiments E of the present invention are E1 to E26:
E1. Use of glycerol, wherein it is as adjuvant or coadjuvant in the preparation of a spraying solution comprising agrochemical compositions.
E2. The use of glycerol as claimed in embodiment 1, wherein it is mixed with vegetable and/or mineral oil.
E3. The use of glycerol as claimed in embodiment 2, wherein said vegetable oils have an oil content varying from 70 wt. % to 99 wt. % relative to the total weight of the oil.
E4. The use of glycerol as claimed in embodiment 2, wherein said vegetable oils are selected from soybean (Glycine max), sunflower (Helianthus annuus), castor-oil plant (Ricinus communis), cotton (Gossypium hirsutum), oil-palm (Attalea speciosa M.), Brazilian oil palm (Elaeis guineensis N.), groundnut (Arachis hypogaea), colza (Brassica campestris), avocado (Persia americana), coconut (Cocos nucifera), maize (Zea mays), cashew nut (Anacardium occidentale), oats (Avena sativa), lupine (Lupinus albus), coffee (Coffeea arabica), flax (Linum grandiflorum), rice (Oryza sativa), cocoa (Theobroma cacao), canola (Brassica napus), olive (Olea europaea), pecan nut (Carya illinoensis), jojoba (Simmondsia chinensis), macadamia (Macadamia ternifolia), Brazil-nuts (Bertholletia excelsa) or mixtures thereof.
E5. The use of glycerol as claimed in embodiment 1 or 2, wherein the glycerol is added to the spraying solution at a rate varying from 1.0 L/ha to 4.0 L/ha.
E6. The use of glycerol as claimed in embodiment 2, wherein the vegetable oil, when mixed with glycerol, is applied at a rate varying from 0.5 L/ha to 2.0 L/ha.
E7. The use of glycerol as claimed in embodiment 1, wherein the agrochemical compositions are selected from insecticides, acaricides, fungicides, herbicides, plant growth regulators, preharvest desiccants, foliar fertilizers or mixtures thereof.
E8. The use of glycerol as claimed in embodiment 7, wherein the agrochemical composition has the form of a suspension of encapsulated products, dispersible concentrate, emulsifiable concentrate, concentrated suspension, suspo-suspension of encapsulated product, suspo-emulsion, soluble granules, soluble concentrate, soluble powder, water-soluble tablets, water-dispersible tablets, dispersible granules, or wettable powder.
E9. A method for the treatment of crops, comprising mixing of glycerol, optionally with vegetable and/or mineral oil, as adjuvant or coadjuvant and at least one agrochemical composition for the preparation of a spraying solution to be applied on the soil and/or crop and/or weeds and/or pests and/or their locality and/or habitat.
E10. The method as claimed in embodiment 9, wherein the vegetable oils have an oil content varying from 70 to 99 wt. % relative to the total weight of the oil.
E11. The method as claimed in embodiment 10, wherein the vegetable oils are extracted from soybean (Glycine max), sunflower (Helianthus annuus), castor-oil plant (Ricinus communis), cotton (Gossypium hirsutum), oil-palm (Attalea speciosa M.), Brazilian oil palm (Elaeis guineensis N.), groundnut (Arachis hypogaea), colza (Brassica campestris), avocado (Persia americana), coconut (Cocos nucifera), maize (Zea mays), cashew nut (Anacardium occidentale), oats (Avena sativa), lupine (Lupinus albus), coffee (Coffeea arabica), flax (Linum grandiflorum), rice (Oryza sativa), cocoa (Theobroma cacao), canola (Brassica napus), olive (Olea europaea), pecan nut (Carya illinoensis), jojoba (Simmondsia chinensis), macadamia (Macadamia ternifolia), Brazil-nuts (Bertholletia excelsa) or mixtures thereof.
E12. The method as claimed in embodiment 9, wherein glycerol is added to the spraying solution at a rate varying from 1.0 L/ha to 4.0 L/ha.
E13. The method as claimed in embodiment 9, wherein the vegetable oil, when added to glycerol, is applied at a rate varying from 0.5 L/ha to 2.0 L/ha.
E14. The method as claimed in embodiment 9, wherein the agrochemical compositions are selected from insecticides, acaricides, fungicides, herbicides, plant growth regulators, preharvest desiccants, foliar fertilizers or mixtures thereof.
E15. The method as claimed in embodiment 14, wherein the agrochemical composition has the form of a suspension of encapsulated products, dispersible concentrate, emulsifiable concentrate, concentrated suspension, suspo-suspension of encapsulated product, suspo-emulsion, soluble granules, soluble concentrate, soluble powder, water-soluble tablets, water-dispersible tablets, dispersible granules, or wettable powder.
E16. The method as claimed in embodiment 9, wherein the spraying solution is applied at a rate varying from 5 L/ha to 600 L/ha.
E17. The method as claimed in embodiment 9, wherein the spraying solution is applied at a rate varying from 100 L/ha to 600 L/ha.
E18. The method as claimed in embodiment 9, wherein the spraying solution is applied at a rate varying from 5 L/ha to 15 L/ha by aerial spraying.
E19. The method as claimed in embodiment 9, wherein the spraying solution is applied at a rate varying from 15 L/ha to 30 L/ha by terrestrial spraying.
E20. The method as claimed in embodiment 9, wherein the crop is selected from soy-bean (Glycine max), cotton (Gossypium hirsutum), haricot bean (Phaseolus spp), pea (Pisum sativum), groundnut (Arachis hypogaea), legumes, maize (Zea mays), rice (Oryza sativa), sorghum (Sorghum bicolor), wheat (Triticum aestivum), millet (Pennisetum glaucum), rye (Secale cereale), barley (Hordeum vulgare), sugarcane (Saccharum officinarum), sunflower (Helianthus annuus), canola (Brassica rapa), potato (Solanum tuberosum), chili pepper (Capsicum annuum), onion (Allium cepa), garlic (Allium sativum), carrot (Daucus carota) or other crops with a perennial cycle, such as citrus (Citrus spp.), coffee (Coffeea arabica), banana (Musa spp.), apple (Malus spp), pear (Pyrus spp), peach (Prunus persica), nectarine (Prunus persica/nusipersica), grape (Vitis spp.), persimmon (Diospyros kaki), mango (Mangifera indica), forestry crops, such as pine (Pinus spp.), eucalyptus (Eucalyptus spp.), acacia (Acacia mearnsii), rubber (Hevea brasiliensis), oil-palm (Elaeis guineensis N.).
E21. A composition of tank mixture for solution for agricultural application by spraying, comprising 1 wt. % to 20 wt. % of glycerol relative to the total weight of the corn-position.
E22. The composition as claimed in embodiment 21, wherein it comprises 1 wt. % to 20 wt. % of glycerol and 0 wt. % to 13 wt. % of oil relative to the total weight of the composition.
E23. The composition as claimed in embodiment 21, wherein it comprises 1 to 20 wt. % of glycerol, 0 wt. % to 13 wt. % of oil and 19 wt. % to 99 wt. % of water relative to the total weight of the composition.
E24. The composition as claimed in embodiment 21, wherein it comprises 1 to 20 wt. % of glycerol, 0 to 13 wt. % of oil, 19 wt. % to 99 wt. % of water and 0.05 wt. % to 1 wt. % of adjuvants relative to the total weight of the composition.
E25. The composition as claimed in embodiment 21, wherein it comprises 1 wt. % to 20 wt. % of glycerol, 0 wt. % to 13 wt. % of oil, 19 wt. % to 99 wt. % of water, 0.05 wt. % to 1 wt. % of adjuvants and 0.001 wt. % to 60 wt. % of agrochemicals relative to the total weight of the composition.
E26. A method for the preparation of a composition for tank mixing, as defined in any one of embodiments 21 to 25, wherein it comprises the stages of addition of the following components to the tank:
   a) an amount from 19 wt. % to 99 wt. % of water,
   b) an amount from 1 wt. % to 20 wt. % of glycerol,
   c) optionally, an amount from 0.05 wt. % to 1 wt. % of adjuvant,
   d) an amount from 0.001 wt. % to 60 wt. % of agrochemical composition,
   e) optionally, an amount from 0 wt. % to 13 wt. % of oil,
   f) water q.s.f. to make up to the capacity of the tank, the percentage by weight of each ingredient being relative to the total weight of the composition, in which stages (b), (c), (d) and (e) can be carried out in any order.

1-15. (canceled)

16. A method for the treatment of crops, comprising
1) preparing a spraying solution by mixing
1.1) at least one agrochemical composition, and
1.2) raw glycerol derived from the production of biodiesel; and
2) applying said spraying solution on the soil and/or crop and/or weeds and/or pests and/or their locality and/or habitat.

17. The method according to claim 16, wherein the raw glycerol has an impurity content in the range of 5 to 50 wt % based on the total weight of the raw glycerol.

18. The method according to claim 16, wherein the raw glycerol comprises at least 1 wt % of an inorganic salt.

19. The method according to claim 16, wherein step 1) comprises the mixing of
1.1) the at least one agrochemical composition,
1.2) the raw glycerol, and
1.3) a vegetable and/or mineral oil.

20. The method according to claim 16, wherein the raw glycerol is added to the spraying solution at 1 to 20 wt %, relative to the total weight of the spraying solution.

21. The method according to claim 16, wherein the spraying solution is applied in an amount of 5 to 600 liters per hectar (L/ha).

22. The method according to claim 16, wherein the spraying solution is applied in an amount of 5 to 15 L/ha by aerial spraying.

23. The method according to claim 16, wherein the spraying solution is applied in an amount of 15 to 30 L/ha by terrestrial spraying.

24. A spraying solution comprising water, raw glycerol derived from the production of biodiesel and an agrochemical composition.

25. The spraying solution according to claim 24, wherein the raw glycerol comprises 60 wt % to 90 wt % glycerol and 1.0 wt % to 20 wt % of inorganic salt relative to the weight of the raw glycerol.
